(19) United States
(12) Patent Application Publication
(10) Pub. No.: US 2015/0056004 A1
(43) Pub. Date: Feb. 26, 2015

(54) Fatigue Resistant Structural Connection

(71) Applicant: Geoffrey Tyler Mitchell, Austin, TX (US)

(72) Inventor: Geoffrey Tyler Mitchell, Austin, TX (US)

(21) Appl. No.: 13/974,067

(22) Filed: Aug. 23, 2013

(51) Int. Cl. F16B 11/00

(52) U.S. Cl. CPC F16B 11/006; F16B 11/00
USPC 403/270

(57) ABSTRACT

One embodiment of a fatigue resistant structural connection that has a primary member 19 coupled to a baseplate 17 with a circumferential weld 18. The connection employs the use of a plurality of stiffeners with elongated, contoured tails 30 coupled to the primary member with a longitudinal weld 27 and coupled to the baseplate with a weld 26. These stiffeners are oriented along the longitudinal axis of the primary member and are laid out radially from this longitudinal axis. The present embodiment: mitigates stress concentrations due to discontinuous connection geometry and therefore improves fatigue resistance, adds a degree of structural redundancy to otherwise non-redundant structures, and provides a means of retrofitting existing tall cantilevered structures. Other embodiments are described and shown.

### CROSS-REFERENCE TO RELATED APPLICATIONS

This application claims the benefit of provisional patent application Ser. No. 61/692,349, filed 2012 Aug. 23 by the present inventor.

### BACKGROUND

### Prior Art

The following is a tabulation of some prior art that presently appears relevant:

U.S. Patents

| Patent Number | Kind Code | Issue Date | Patentee |
|---|---|---|---|
| 6,857,808 | B1 | 2005 Feb. 22 | Sugimoto et al. |

### Nonpatent Literature Documents

National Cooperative Highway Research Program (NCHRP), “Document 176” (March 2011)

Fatigue cracks in structures can often be the consequence of induced principal stress concentrations due to the inherent geometry of a connection. As stress changes trajectory throughout a connection large principal stresses develop at points of discontinuous geometry. Over many cycles of loading this local stress increase can degrade the material in a cumulative fashion and ultimately cause fracture. Fatigue cracks are of particular concern for cyclically loaded non-redundant structures because a fracture in such a structure could result in collapse.

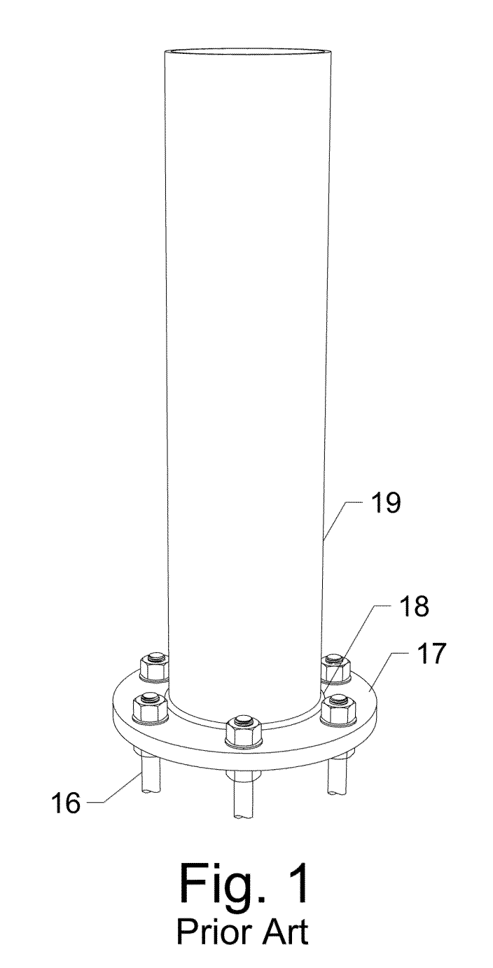

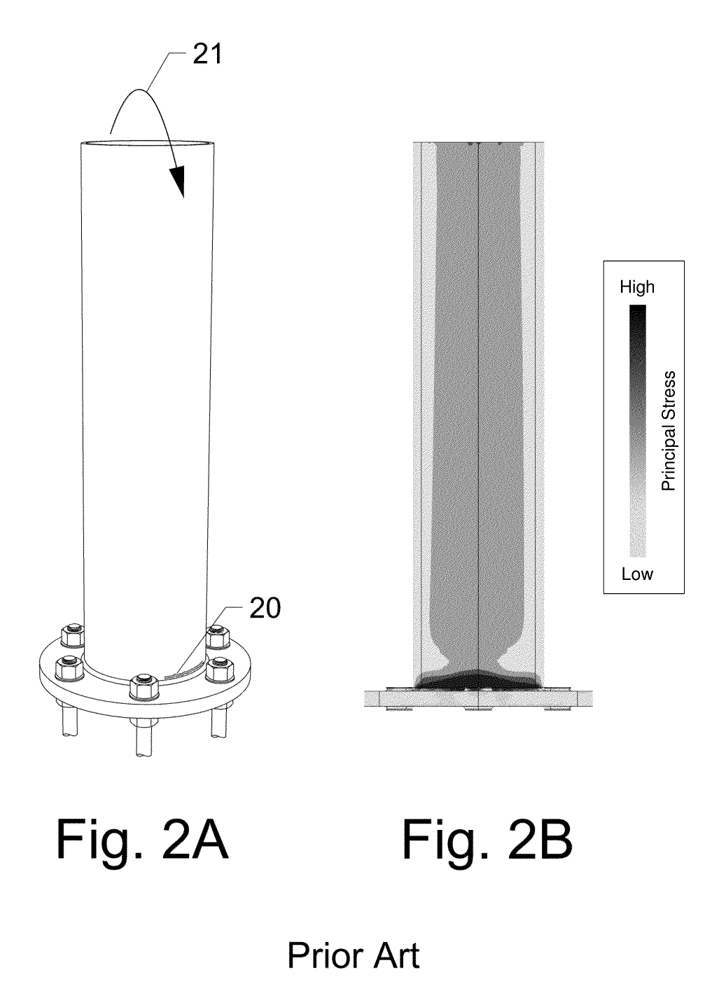

An example of this type of structure would be a high-mast luminaire that employs a simple baseplate connection as shown in FIG. 1. These types of structures are susceptible to fatigue cracking at the circumferential weld 18 at the interface of the primary member 19 and the baseplate 17. The reason for this is that large stress concentrations that are developed when the membrane stress leaves the wall of the primary member 19, enters the baseplate 17, and finally resolves into the anchor bolts 16. These large stress concentrations are easily observed analytically and experimentally. FIG. 2B shows an elastic principal stress plot that was generated from a finite element analysis (FEA) model. It is plain to see from FIG. 2B that a large stress concentration is induced from the applied lateral load 21 shown in FIG. 2A. Experimentally, there has been recent research (NCHRP, 2011) that has shown that the simple baseplate detail shown in FIG. 1 does not perform as designed because the fatigue crack 20 develops much faster than expected.

Because of the catastrophic nature of a fatigue collapse of a tall structure there is motivation to find a connection detail that will ameliorate the induced stress concentrations inherent to the simple baseplate connection (FIG. 1). The following are some prior art examples of design attempts to solve this problem.

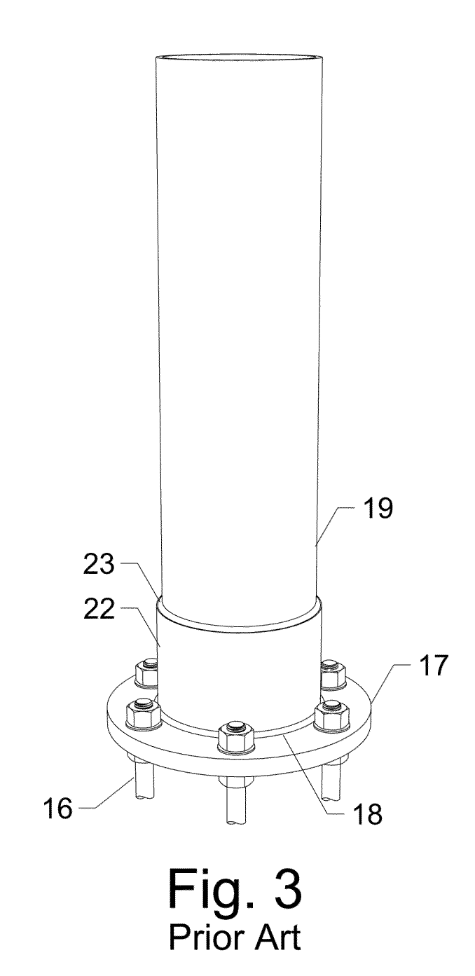

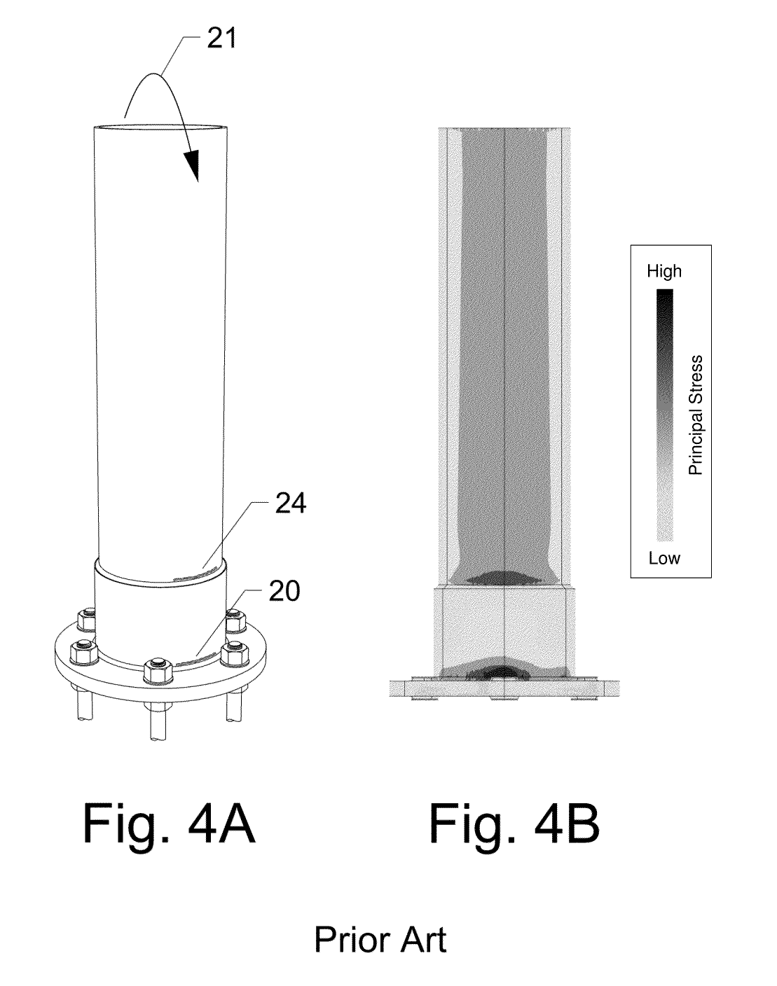

FIG. 3 shows a perspective view of a simple baseplate connection with a reinforcing collar 22. This collar is added concentrically around the primary member and has a circumferential weld 18 to the baseplate and also a circumferential weld 23 to the primary member. This is an attempt to increase the wall thickness of the connection and therefore reduce the principal stresses. Using a FEA model, FIG. 4B shows that the stress concentrations are mitigated but are still significant. Research has shown that fatigue cracking occurs at the locations of both circumferential welds 20 and 24 as indicated in FIG. 4A. Although principal stress concentrations are slightly reduced, the reinforcing collar does not provide any redundancy because a crack at either circumferential weld location would be catastrophic to the structure. Additionally, the reinforcing collar does not lend itself well to retrofit applications because a very close fit is required between the reinforcing collar and the primary member.

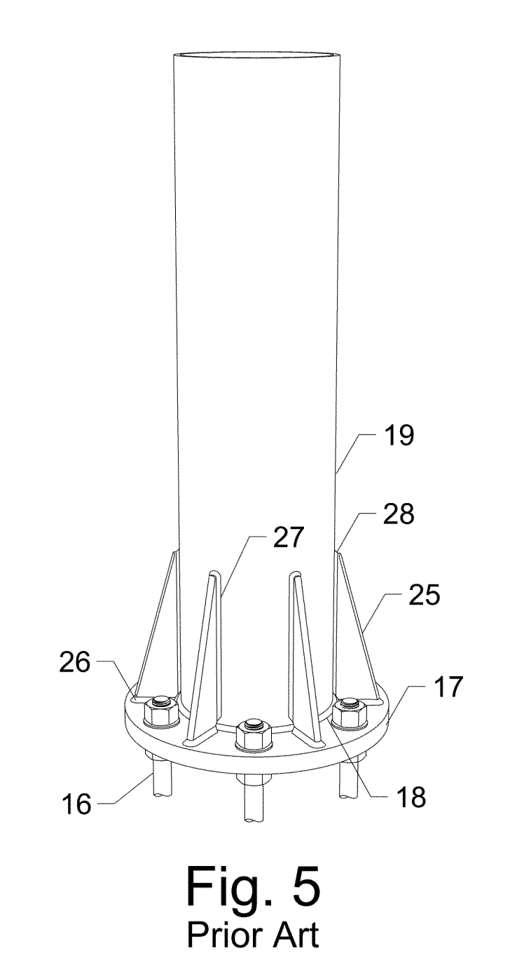

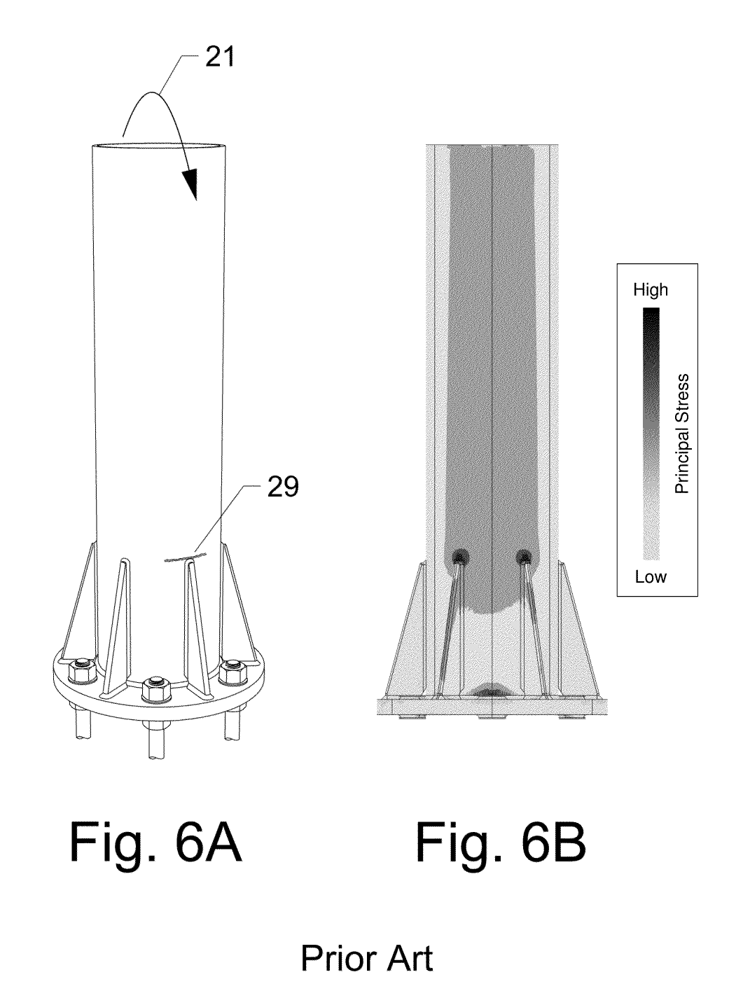

Triangular stiffeners 25 are often used to mitigate the out-of-plane bending at the location of the circumferential weld to the baseplate 18 and are effective in reducing principal stress concentrations in this area. The triangular stiffeners are coupled to the primary member by a longitudinal weld 27 and a weld to the baseplate 26. However, installing a plurality of triangular stiffeners to a simple baseplate connection as shown in FIG. 5 creates a principal stress concentration at the toe of the connection 28 to the primary member. The FEA principal stress plot in FIG. 6B clearly shows this stress concentration, and the location of observed fatigue cracks 29 is indicated in FIG. 6A.

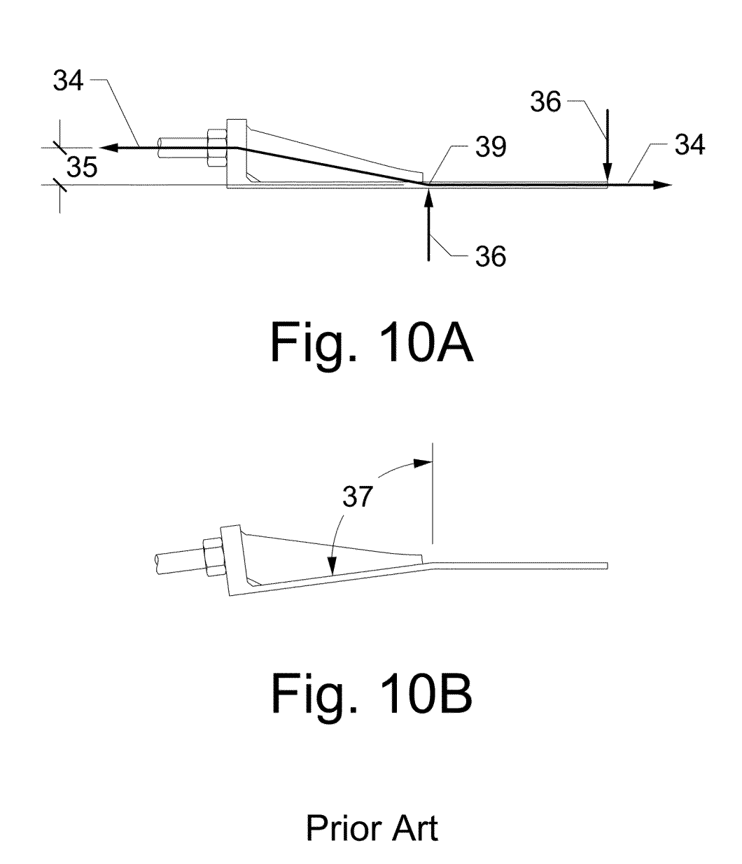

A brief examination of the free-body-diagram shown in FIG. 10A will show why this stress concentration occurs. If an axial force 34 is applied to the free body, there is a connection eccentricity 35 that must be resolved. The triangular stiffener presents a direct load path to the anchor bolt and there is necessarily a point where the stress changes trajectory 36. The free body is equilibrated by force couple 36 and the resulting displacement is shown in FIG. 10B. The free body will rotate significantly 37 because of the low flexural stiffness at the point of stress trajectory 39. There is a discontinuity in stiffness, and therefore a principal stress concentration.

Additionally, a system of triangular stiffeners does not add structural redundancy to a simple baseplate connection because this system adds an additional location of stress concentration in the wall of the primary member. A fracture through the wall of the primary member in any location can result in collapse.

Finally, another connection design that addresses this problem is documented in U.S. Pat. No. 6,857,808 to Sugimoto et al. This solution involves the use of U-shaped and V-shaped stiffeners that are coupled to the primary member and the baseplate. It is not clear how these stiffeners perform in service, and one significant drawback is that the curved geometry makes this design difficult to fabricate and fit up.

### SUMMARY

In accordance with one embodiment a fatigue resistant structural connection comprises a primary member of closed cross-section, a transverse baseplate, and a plurality of stiffeners with elongated, contoured tails.

### Advantages

There are several advantages of one or more embodiments as follows: to mitigates stress concentrations due to discontinuous connection geometry and therefore improve fatigue resistance, to add a degree of structural redundancy to otherwise non-redundant structures, and to provide a means of retrofitting existing structures in order achieve the previous advantages mentioned above.

### DRAWINGS

### Figures

The related drawings in connection with the detailed description of each embodiment, which is to be made later, are briefly described as follows, in which:

FIG. 1 is perspective view of a prior-art simple baseplate connection.

FIG. 2A is a perspective view similar to FIG. 1 that shows applied loading and fatigue cracking.

FIG. 2B is an elastic analysis contour plot for the baseplate connection shown in FIG. 2A.

FIG. 3 is perspective view of a prior-art baseplate connection with reinforcing collar.

FIG. 4A is a perspective view similar to FIG. 3 that shows applied loading and fatigue cracking.

FIG. 4B is an elastic analysis contour plot for the baseplate connection shown in FIG. 4A.

FIG. 5 is perspective view of a prior-art baseplate connection with triangular stiffeners.

FIG. 6A is a perspective view similar to FIG. 5 that shows applied loading and fatigue cracking.

FIG. 6B is an elastic analysis contour plot for the baseplate connection shown in FIG. 6A.

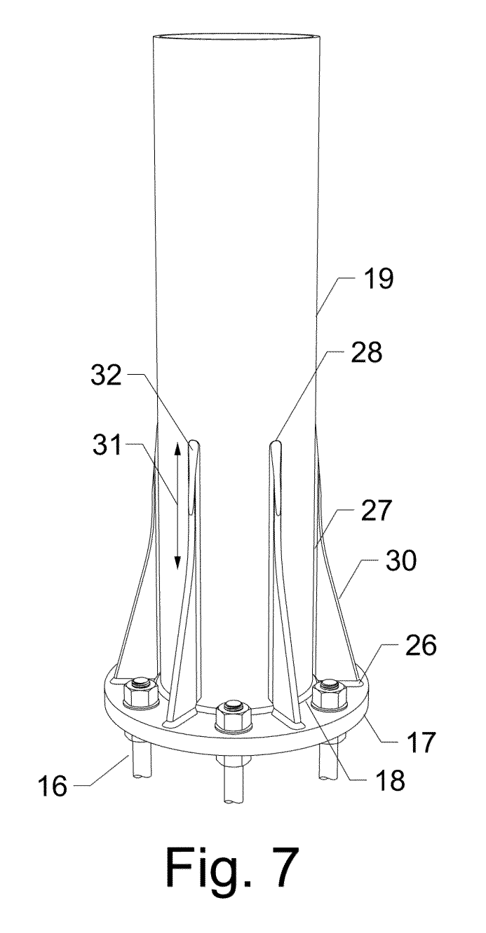

FIG. 7 is a perspective view of the first embodiment.

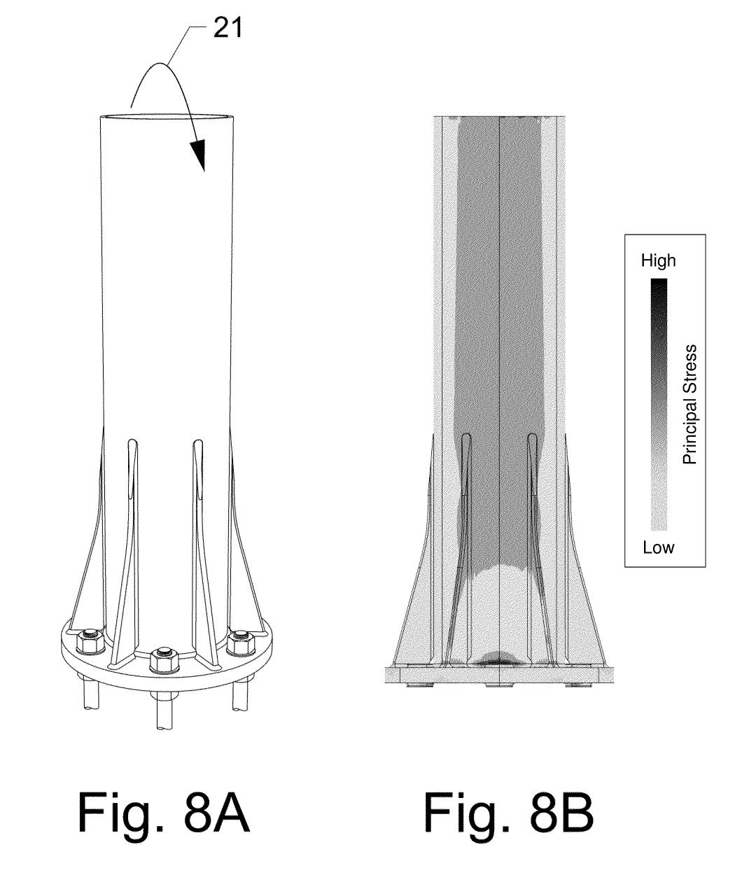

FIG. 8A is a perspective view similar to FIG. 7 that shows applied loading.

FIG. 8B is an elastic analysis contour plot for the first embodiment shown in FIG. 8A.

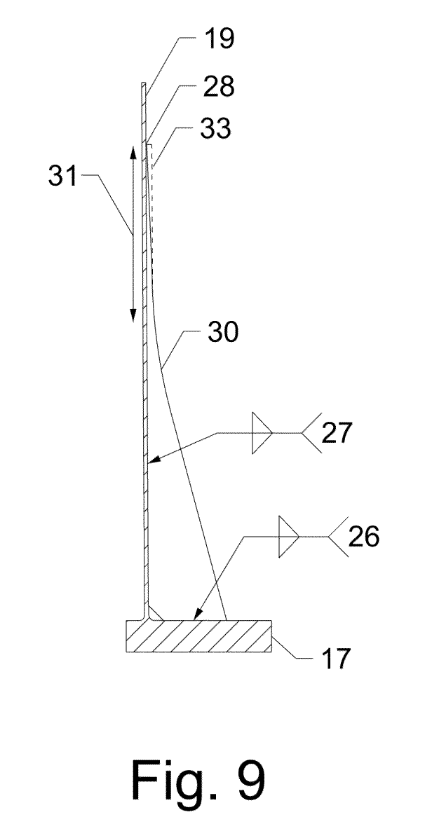

FIG. 9 is a section detail view of the first embodiment.

FIG. 10A is a free-body-diagram of a prior-art baseplate connection with triangular stiffeners.

FIG. 10B is a diagram of displacement due to applied loading shown in FIG. 10A.

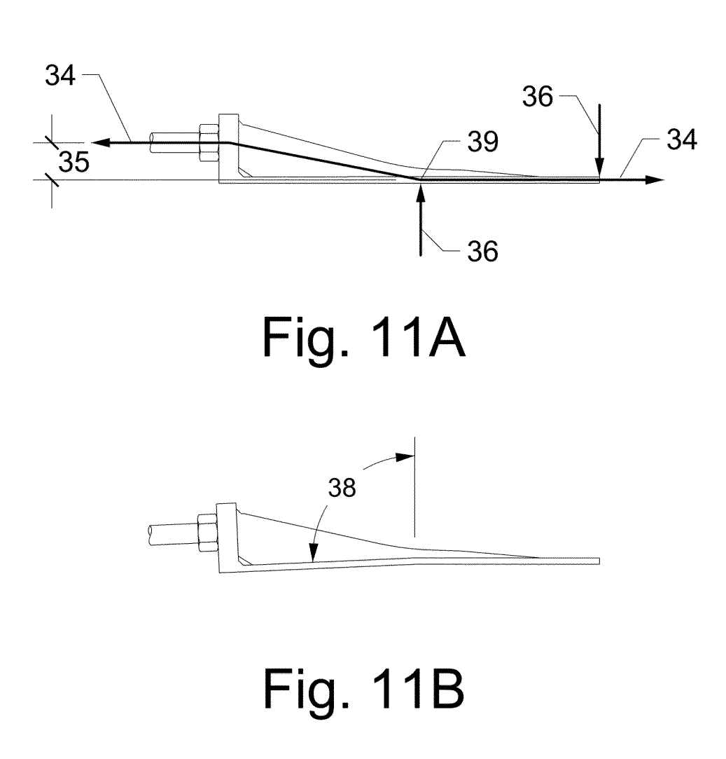

FIG. 11A is a free-body-diagram of the first embodiment.

FIG. 11B is a diagram of displacement due to applied loading shown in FIG. 11A.

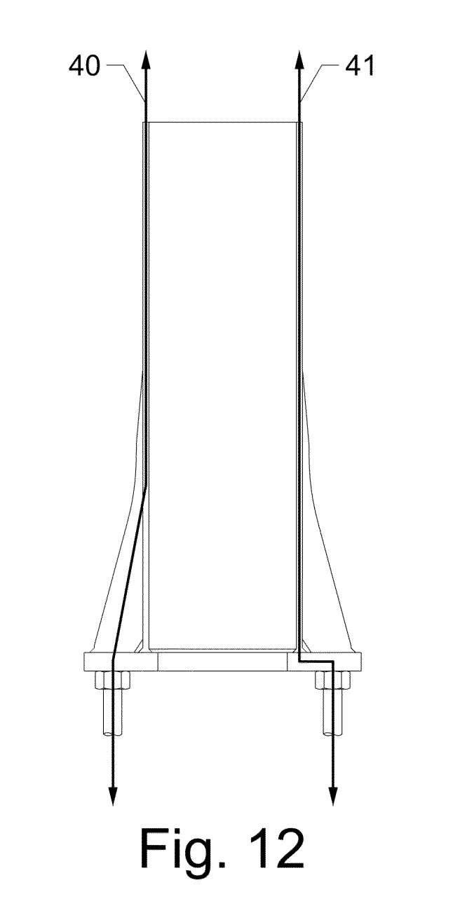

FIG. 12 is a section view of the first embodiment that shows two independent load paths.

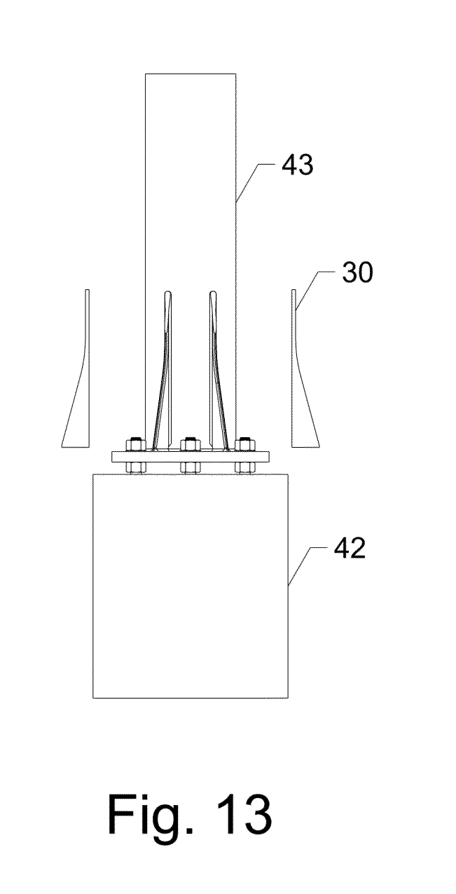

FIG. 13 is an exploded view of an additional embodiment.

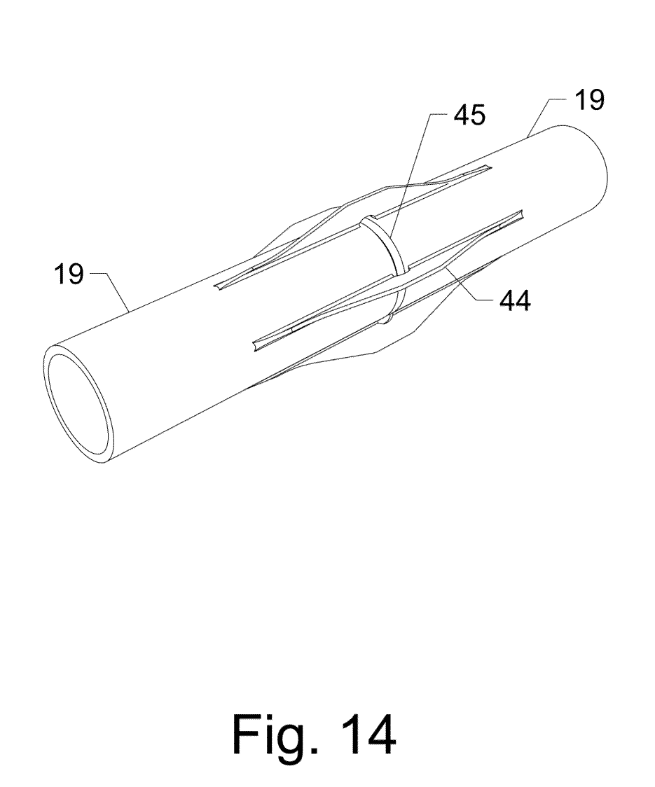

FIG. 14 is a perspective view of an additional embodiment.

Drawings-Reference Numerals

| | |
|---|---|
| 16 | foundation anchor bolt |
| 17 | baseplate |
| 18 | circumferential weld to baseplate |
| 19 | primary member of closed cross-section |
| 20 | fatigue crack at circumferential weld to baseplate |
| 21 | applied overturning force |
| 22 | reinforcing collar |
| 23 | circumferential weld of collar to primary member |
| 24 | fatigue crack at circumferential weld of collar to primary member |
| 25 | triangular stiffener |
| 26 | weld connecting stiffener to baseplate |
| 27 | longitudinal weld connecting stiffener to primary member |
| 28 | toe of connection of stiffener to primary member |
| 29 | fatigue crack at toe of connection of stiffener to primary member |
| 30 | stiffener with elongated, contoured tail |
| 31 | elongated tail section |
| 32 | contoured area of tail section |
| 33 | base metal removed |
| 34 | applied axial force |
| 35 | connection eccentricity |
| 36 | reaction from connection eccentricity |
| 37 | rotation of connection with triangular stiffener |
| 38 | rotation of connection with stiffener with elongated, contoured tail |
| 39 | point of stress trajectory |
| 40 | load path through stiffener |
| 41 | load path through circumferential weld to baseplate |
| 42 | concrete foundation |
| 43 | existing unreinforced structure |
| 44 | stiffener with symmetric elongated, contoured tails |
| 45 | transverse joint |

### DETAILED DESCRIPTION

### First Embodiment

One embodiment of the fatigue resistant structural connection is illustrated in FIG. 7. The connection has a primary member 19 coupled to a baseplate 17 with a circumferential weld 18. The baseplate is a means to attach the connection to a foundation element via the anchor bolts 16. The connection employs the use of a plurality of stiffeners with elongated, contoured tails 30 coupled to the primary member with a longitudinal weld 27 and coupled to the baseplate with a weld 26. These stiffeners are oriented along the longitudinal axis of the primary member and are laid out radially from this longitudinal axis.

The elongated tail section 31 is integrated with the stiffener and features a tapered contour 32 that feathers the stiffener to a shallow angle relative to the longitudinal axis of the primary member. The taper at its extreme end at the toe of the connection of the stiffener to the primary member 28 is as thin as possible.

In one embodiment the entire connection is comprised of a steel weldment, however the advantages of this connection stem from principles of mechanics of solids and are therefore not specific to any one material.

### Operation

In one embodiment, shown in FIG. 9, a stiffener with an elongated tail, without a contour, is cut from plate stock. The stiffener is coupled to the primary member 19 by a pair of longitudinal fillet welds 27 and to the baseplate 17 by another pair of fillet welds 26. The welding can be done by any appropriate arc welding process.

After the welding has been completed, the elongated tail of the stiffener 31 is then contoured using a grinding or cutting process to remove metal 33 from the elongated tail to a shallow angle relative to the longitudinal axis of the primary member. The toe of the connection of the stiffener to the primary member 28 should be as thin as possible without gouging or grinding into the base metal of the primary member. After these processes are complete the geometry of the stiffener with an elongated, contoured tail 30 is achieved. The stiffener with the long tail prior to contouring allows for the tail of the stiffener to be welded to the primary member without burning through the stiffener material. With the base metal of the long tail and weld metal of the two longitudinal fillet welds in place, the grinding operation can then be performed without damaging or compromising the base material of the primary member.

Alternatively the connection can be fabricated as a monolith using a subtractive process such as machining or an additive process such as 3D printing or casting.

### Additional Embodiments

An additional embodiment is shown in FIG. 14. In this embodiment two primary members 19 are coupled with a transverse joint 45. A plurality of stiffeners with symmetric elongated, contoured tails 44 span the joint and are coupled to the two primary members using one of the processes outlined in the first embodiment.

### CONCLUSIONS, RAMIFICATIONS AND SCOPE

Accordingly, the reader will see that the fatigue resistant structural connection has several features that make it superior to prior art designs. FIG. 8B shows a FEA principal stress plot of one embodiment after applying a lateral load 21 shown in FIG. 8A. Compare the principal stress plot of FIG. 8B to the principal stress plot of FIG. 6B. FIG. 8B indicates that the principle stress concentrations at the toe of the connection of the stiffener to the primary member 28 are eliminated. This suggests that the fatigue resistance of the present embodiment is superior to that of the prior art connection designs.

A brief examination of FIGS. 11A and 11B will explain how the present embodiment eliminates this principal stress concentration. If an axial force 34 is applied to the free body in FIG. 11A, there is a connection eccentricity 35 that must be resolved. The stiffener with an elongated, contoured tail presents a direct load path to the anchor bolt and there is necessarily a point where the stress changes trajectory 36. The free body is equilibrated by force couple 36 and the resulting displacement is shown in FIG. 11B. The free body will rotate much less 38 than prior art designs shown in FIG. 10B because the elongated tail provides a developed increase in flexural stiffness at the point of stress trajectory 39.

Additionally, because the principal stress concentration at the toe of the connection of the stiffener and primary member is eliminated, the present embodiment provides for additional degree of structural redundancy to a non-redundant structure compared to a simple baseplate connection or a system of triangular stiffeners. This is because the likely fatigue fracture location has moved away from the wall of the primary member. A fatigue crack will likely occur in either the circumferential weld 18 to the baseplate or the weld 26 connecting the stiffener to the baseplate. A fatigue fracture in either one of these locations will not result in structural collapse because the fatigue resistant structural connection provides for two independent load paths as is shown in FIG. 12. One path 40 allows for stress to reach the anchor bolts 16 through the stiffener, and the other path 41 allows for stress to reach the anchor bolts through the circumferential weld 18 to the baseplate.

The present embodiment is also well-suited for retrofitting existing structures because of the simple planar geometry of the stiffener with elongated contoured tail. Retrofit applications of the invention can be installed by field-welding and contouring in situ while the structure is in service. A schematic of this operation is shown in FIG. 13. In this illustration an existing unreinforced structure 43 is supported upon a concrete foundation 42. A plurality of stiffeners with elongated contoured tails 30 is simply fit up and field welded to the structure. After the welding is complete, the grinding operation to contour the stiffener is performed. This is potentially an economical way to rehabilitate or reinforce existing structures without incurring the expense of decommissioning and erecting a tall structure.

Another benefit the additional degree of redundancy that the present embodiment provides is the ability to repair damaged structures. A retrofit application of the fatigue resistant structural connection would make it possible to repair cracks (back gouging, grinding, welding, et cetera) discovered at circumferential welds of existing structures while the structure is in service.

Although the description above contains many specifics, these should not be construed as limiting the scope of the embodiments but as merely providing illustrations of some of several embodiments.

Thus the scope of the embodiments should be determined by the appended claims and their legal equivalents, rather than by the examples given.

I claim:

1. A structural connection, comprising:

2. (a) a primary member of closed cross-section where the wall thickness is thin relative to any gross cross-sectional dimension, and

3. (b) a baseplate coupled to said primary member at an orientation approximately transverse to the longitudinal axis of said primary member, and

4. (c) a plurality of stiffeners with elongated, contoured tails which are coupled to said primary member and said baseplate,

5. whereby longitudinal stresses within the thin wall of said primary member can transfer directly into said baseplate without inducing stress concentrations in said thin wall of said primary member, and a degree of structural redundancy is added to the connection.

6. The method of claim 1 wherein said structural connection is assembled by welding or adhesion.

7. The method of claim 1 wherein said structural connection is comprised of a monolithic assembly manufactured by an additive or subtractive process.

8. A structural connection, comprising:

9. (a) a plurality of primary members of closed cross-section where the wall thickness is thin relative to any gross cross-sectional dimension, and

10. (b) a plurality of stiffeners with symmetric elongated, contoured tails which are coupled to said primary members such that said plurality of stiffeners span a joint coupling said plurality of primary members,

11. whereby longitudinal stresses within the thin wall of one of said primary members can transfer directly to the thin wall of an adjacent primary member without inducing stress concentrations in the thin wall of any of the said primary members, and a degree of structural redundancy is added to the connection.

12. The method of claim 8 wherein said structural connection is assembled by welding or adhesion.

13. The method of claim 8 wherein said structural connection is comprised of a monolithic assembly manufactured by an additive or subtractive process.
